(19) United States
(12) Patent Application Publication
(10) Pub. No.: US 2008/0256809 A1
(43) Pub. Date: Oct. 23, 2008

(54) Cutting tool having replaceable blade

(75) Inventors: Steven M. Macsay, Strongsville, OH (US); Glen R. Chartier, Avon Lake, OH (US); David L. Machovina, Lorain, OH (US)

Correspondence Address: RANKIN, HILL & CLARK LLP, 38210 Glenn Avenue, WILLOUGHBY, OH, 44094-7808, US

(73) Assignee: Emerson Electric Co.

(21) Appl. No.: 11/788,979

(22) Filed: Apr. 23, 2007

(51) Int. Cl. B26B 13/04

(52) U.S. Cl. 30/261

(57) ABSTRACT

A cutting tool is described that enables quick and simple blade replacement. The cutting tool utilizes a pair of handles configured in a scissor-like arrangement. A cutting blade is releasably engaged with one of the handles. A spring or other biasing member urges the handles apart from one another.

### FIELD OF THE INVENTION

The present invention relates to a cutting tool having a blade that can be easily replaced, and preferably, can be replaced without the use of any tools.

### BACKGROUND

Single handle cutting tools are known in the art such as conventional “box type” cutters. These types of cutters often use retractable blades which are secured to a retractable member that may be slid into or out of the handle of the tool. Often the blade is retained within such single handle tools by trapping the blade within a channel which is formed by engaging two faces or halves of the handle together. Thus, when a user wishes to replace or add a new blade to such a cutter, one or more retaining screws are removed thereby allowing the two handle halves to be pulled apart from one another, and a new blade then inserted into the interior of the handle. Although satisfactory, a need remains for an improved cutting tool, particularly a tool having a scissors or pliers type configuration in which two handles are pivotally attached to one another.

Scissors or pliers-like cutting tools having replaceable blades are also known in the art. In such devices, a first handle generally defines a cradle end of the tool for holding the associated workpiece, and a second handle, pivotally attached to the first handle, defines or carries a cutting blade for engaging the workpiece disposed in the cradle area. Typically, a cutting blade is engaged and secured to one of the handles using roll pins or screws that extend through apertures in the blade. The roll pins or screws, extending from the handle, engage holes defined in the blade and serve to hold the blade with respect to the handle. The roll pins or screws also serve to resist and generally transfer forces imparted through the connection between the blade and the handle during use of the tool. However, in order to replace the blade, these pins or screws must be either removed or disengaged from the blade. This is often a difficult and tedious operation since the screws used to attach the blade to the handle are usually relatively small and thus have correspondingly small heads and small slots with shallow channels for receiving a screw driver. Another disadvantage associated with the prior art practice of using such screws for attaching a blade to a handle in two handled cutting tools, is that after repeated blade replacements, the screw heads often become worn or otherwise damaged such that even greater difficulty is encountered in attempting to remove or tighten the screws. Although most currently known cutting tools of this type are satisfactory, a need remains for an improved cutting tool and blade assembly, and particularly one that avoids the use of pins or screws when replacing the blade.

### SUMMARY

In a first aspect, the present invention provides a cutting tool comprising a first handle having a recessed receiving region adapted for retaining a workpiece, a distal end, and a body extending between the receiving region and the distal end. The cutting tool also comprises a second handle pivotally and releasably coupled to the first handle. The second handle has a blade attachment portion, a distal end, and an intermediate region extending between the blade attachment portion and the distal end. The second handle defines a hollow blade receiving region accessible through a blade receiving slot. The hollow blade receiving region defines a relatively flat blade receiving face. The second handle further has at least one blade retention member projecting from the blade receiving face and either permanently affixed or integral with the second handle, within the hollow blade receiving region.

In another aspect, the present invention provides a tool adapted for cutting tubing or other cylindrical members. The tool comprises a first handle having a recessed receiving region, a distal end, and a body extending between the receiving region and the distal end. The first handle defines a generally hollow interior accessible along an underside of the handle. The tool also comprises a second handle at least partially disposed within the hollow interior of the first handle. The second handle is pivotally and releasably coupled to the first handle. The second handle defines a blade attachment portion, a distal end, and an intermediate region extending between the blade attachment portion and the distal end. The blade attachment portion defines a hollow blade receiving region including a blade receiving face and at least one blade retention member projecting from the blade receiving face and which is permanently affixed or integral with the second handle. The tool further comprises a cutting blade having two oppositely directed blade faces, a cutting edge, a non-cutting edge, and at least one receiving slot defined and accessible along the non-cutting edge. The cutting blade is disposed along the blade receiving face of the second handle such that one of the blade faces contacts the blade receiving face of the second handle and at least one of the blade retention members is disposed within a receiving slot of the cutting blade.

In yet another aspect of the present invention, a cutting tool is provided that comprises a pair of handles pivotally and releasably engaged to one another. One of the handles defines a blade receiving face and at least one blade retention member projecting outward from the face. The cutting tool further comprises a cutting blade defining at least one receiving slot along an edge of the blade. The blade is retained in the tool and disposed alongside and contacting the blade receiving face such that at least one permanent blade retention member is positioned generally within at least one receiving slot of the cutting blade.

And, in another aspect, the present invention provides a cutting blade adapted for incorporation in and use with, a cutting tool. The blade includes first and second faces, a linear cutting edge, and three non-cutting edges. The blade includes two apertures and at least two recesses defined along two or more of the non-cutting edges of the blade.

### BRIEF DESCRIPTION OF THE DRAWINGS

FIG. 1 illustrates a preferred embodiment cutting tool in accordance with the present invention.

FIG. 2 is an exploded view of the preferred embodiment cutting tool depicted in FIG. 1.

FIG. 3 is a detailed view of a preferred embodiment cutting blade and its engagement within the preferred embodiment cutting tool.

FIG. 4 is a detailed view of a first handle of the preferred embodiment cutting tool of the present invention.

FIG. 5 is a detailed view of a second handle of the preferred embodiment cutting tool according to the present invention.

FIG. 6 is a detailed planar view of the second handle shown in FIG. 5, illustrating a blade receiving slot.

FIG. 7 is a detailed view of the preferred embodiment cutting blade used in the preferred embodiment cutting tool of the present invention.

### DETAILED DISCUSSION

The present invention provides a cutting tool having a configuration in which two handles are pivotally attached to one another and a cutting blade is releasably attached to or otherwise engaged with one of the handles. In accordance with the present invention, various provisions are provided that enable easy removal and replacement of the cutting blade. This is in contrast to prior art cutting tools in which removal or replacement of the blade was difficult or cumbersome and typically required removal of multiple screws in order to release or disengage the blade from the tool.

In accordance with the present invention, permanent pins are formed or otherwise embedded into a portion of a handle of the cutting tool. The pins are adapted for engagement into recessed notches formed along the edge of a cutting blade specifically tailored for use in the tool. In this manner, the blade can be simply withdrawn from the handle portion as removable metal pins or screws otherwise used as in the prior art, do not pass through holes or apertures in the blade. Instead, the permanent pins engage the blade by receipt into appropriately sized and positioned notches defined along the blade edge. A single screw or other similar pivot or hinge member is used to retain the two handles together and enable pivotal movement between the handles. Preferably, that same single screw or pivot member also extends through an aperture defined in the cutting blade.

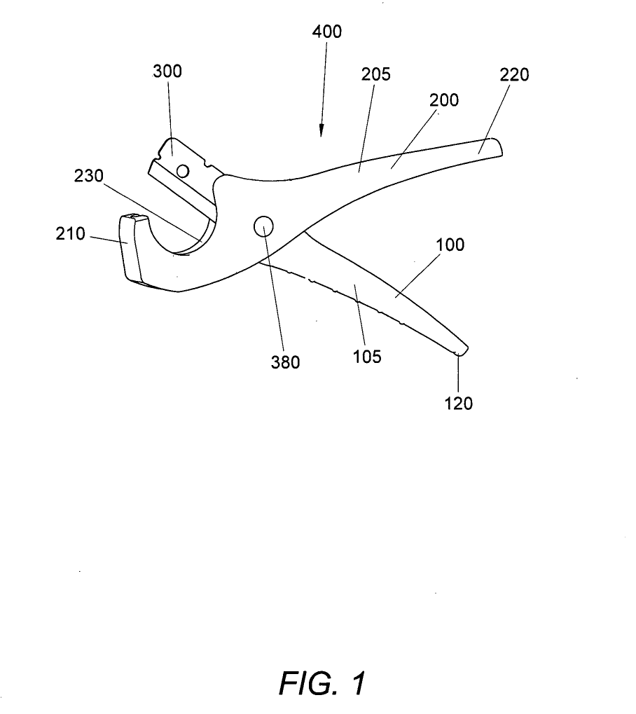

FIG. 1 illustrates a first preferred embodiment cutting tool 400 in accordance with the present invention. The cutting tool 400 comprises a handle 100, another handle 200, a blade 300, and a pivot member 380 that engages the handles 100 and 200 together. The handle 100 includes a blade attachment portion (not shown) along which a portion of the blade 300 extends, a distal end 120 and a handle body 105 generally extending therebetween. The handle 200 includes a nose 210, a recessed receiving region 230 generally adapted for receiving and retaining a workpiece to be cut, a distal end 220, and a handle body 205 generally extending therebetween. The blade 300 is releasably engaged to one of the handles 100 and 200, as described in greater detail herein.

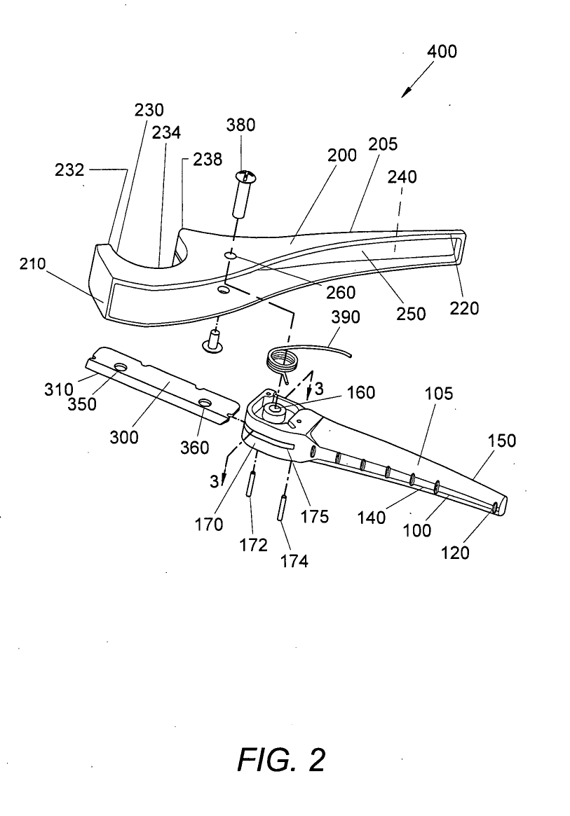

FIG. 2 is an exploded view of the preferred embodiment cutting tool 400 depicted in FIG. 1. Specifically, the handle 100 defines an outer gripping region 140 extending along the handle body 105 generally between the distal end 120 and a blade receiving end 170. An inner region 150 accessible from a region opposite the gripping region 140, generally extends between the blade receiving end 170 and the distal end 120 of the handle 100. The handle 100 also defines a first blade receiving slot 175 defined along the end 170. The handle 200 defines an outer gripping region 240 extending along the handle body 205 generally between the distal end 220 and the receiving region 230, and specifically from a handle ridge 238. An inner region 250 generally extends between a nose end 210 at which the receiving region 230 is defined, and the distal end 220. The receiving region 230 is generally defined by a concave or recessed surface 234 extending between the handle ridge 238 and a second ridge 232 defined adjacent the nose 210. As illustrated in FIG. 2, upon assembly of the tool 400, one of the handles, i.e. the handle 100, is at least partially disposed in a hollow region or interior of the other handle, i.e. handle 200.

The tool 400 also comprises a blade 300 that is received within the handle 100. The blade 300 defines a cutting edge 310. Specifically, the blade 300 is sized and adapted for insertion into the blade receiving slot 175 defined in the handle 100. The blade 300, as described in greater detail herein, defines one or more notches or recessed portions along its outer edge that serve to receive and engage blade retention members, such as retaining pins 172 and 174 that are formed or otherwise permanently affixed within the handle 100. The blade 300 also preferably defines one or more apertures 350, 360 which are also described in greater detail herein.

The tool 400 further comprises the pivot member or pivot assembly 380. The pivot member 380 engages both handles 100 and 200 and enables pivotal movement of the handles relative to one another. Preferably, the member 380 extends through one or more apertures 260 defined in the handle 200 and one or more apertures 160 defined in the handle 100. The member 380 also preferably extends through the blade 300.

The tool 400 also comprises a spring 390 or other biasing member that is positioned or otherwise engaged with the handles 100 and 200, such that upon assembly of the tool 400, the distal ends 120 and 220 of the handles 100 and 200, respectively, are urged apart from one another. As shown in FIG. 2, the spring 390 can be in the form of a torsional coil spring, engaging both handles 100 and 200, and positioned such that the pivot member 380 extends through the open interior region of the spring 390. Preferably, the spring 390 is disposed in a generally hollow or recessed spring compartment defined within the handle 100. The present invention also includes an embodiment of the cutting tool in which multiple springs are used.

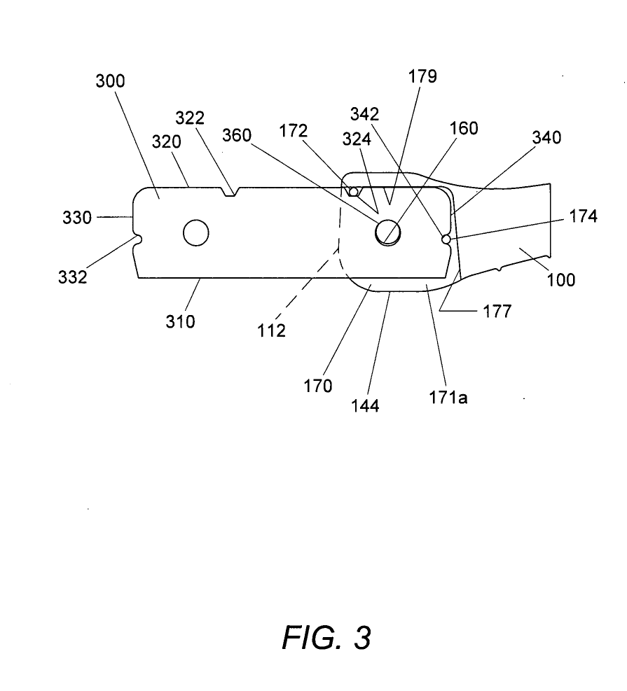

FIG. 3 is a detailed view taken along line 3-3 in FIG. 2, of the blade receiving end 170 of the handle 100 illustrating positioning of the blade 300 relative thereto. The handle 100 defines a relatively flat pair of blade receiving faces 171a and 171b (not shown) that are generally parallel to one another and extend within and define an interior region of the handle 100, accessible along the blade receiving slot 175 (see FIG. 2). The face 171a generally extends between a nose end 112 and a rear ledge 177 of the handle 100, and from a front underside region 144 to an upper ledge 179 of the handle 100. The two opposing faces 171a and 171b (not shown) and ledges 177 and 179 define a generally hollow interior accessible via the blade receiving slot 175 of the handle 100. The retaining pins 172 and 174 disposed in the handle 100 are evident. Preferably, the retaining pin 172 or other blade retention member is disposed adjacent the front end of the handle 100 and thus, proximate the nose end 112. And, preferably, the retaining pin 174 or other blade retention member is disposed between the retaining pin 172 and the distal end 120 of the handle 100.

The blade 300 is generally rectangular in shape defining a cutting edge 310 that extends between two lateral edges 330 and 340. A blade top edge 320 extends generally parallel to the cutting edge 310 and extends between the two lateral edges 330 and 340. Preferably, the lateral edges 330 and 340 and the top edge 320 are non-cutting edges. Defined along each of the lateral edges 330 and 340 are recessed regions 332 and 342, respectively. Also defined along the top edge 320 are one or more recessed regions 322 and 324. The provision of the various recessed regions or slots accessible along the perimeter edge of the blade, and the associated retaining pin(s) or retention member(s) in the handle, are a unique feature of the present invention. The recessed regions or slots defined in the blade edge, as described in greater detail herein, enable the blade to be easily removed from the associated handle, and avoid the requirement as with prior art cutting devices, of having to remove screws that affix the blade to the handle.

Upon appropriate positioning of the blade 300 within the slot 175 of the handle 100, a first face of the blade is directed towards, and preferably at least partially in contact with the face 171a of the handle 100. The blade 300 is positioned such that the lateral edge 340 of the blade 300 is proximate the rear ledge 177, and preferably such that the retaining pin 174 is generally disposed within the receiving region 342 defined along the edge 340. Similarly, the blade 300 is also preferably positioned such that the top edge 320 of the blade 300 is proximate and most preferably, in contact with the ledge 179. The retaining pin 172 is preferably disposed within the receiving region 324 defined in the edge 320. And, it is also preferred that the aperture 360 defined in the blade 300 is aligned with the aperture 160 defined in the handle 100. As noted herein, the present invention cutting tool includes the use of only one blade retention member. In this embodiment, it is preferred that only the rearward retention member be used, such as retention pin 174. The top edge 320 of the blade 300 would then preferably be in contact with and be supported by the ledge 179. This configuration of the blade top edge 320 contacting the ledge 179, promotes transfer of forces applied to the handle 100, to the blade 300.

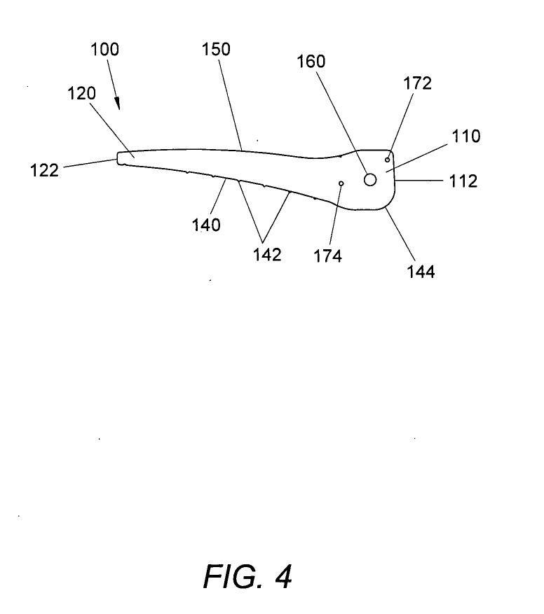

FIG. 4 is a side elevational view of the handle 100. The previously described nose end 112, distal end 120, gripping region 140, and inner region 150 are shown. Defined along the gripping region 140 are a plurality of raised ridges or projections 142 that promote gripping and reduce the tendency for a user's hand to slip along that region of the handle 100. The ridges 142 may be defined anywhere along the gripping region 140 between the distal end 120 and the front underside region 144 of the handle 100. A tail end 122 is defined at the rearward portion of the distal end 120. The handle 100 defines the aperture 160 that preferably provides access through the thickness of the handle. Apertures for the retaining pins 172 and 174 are illustrated. The handle 100 includes a forward end 110 as shown.

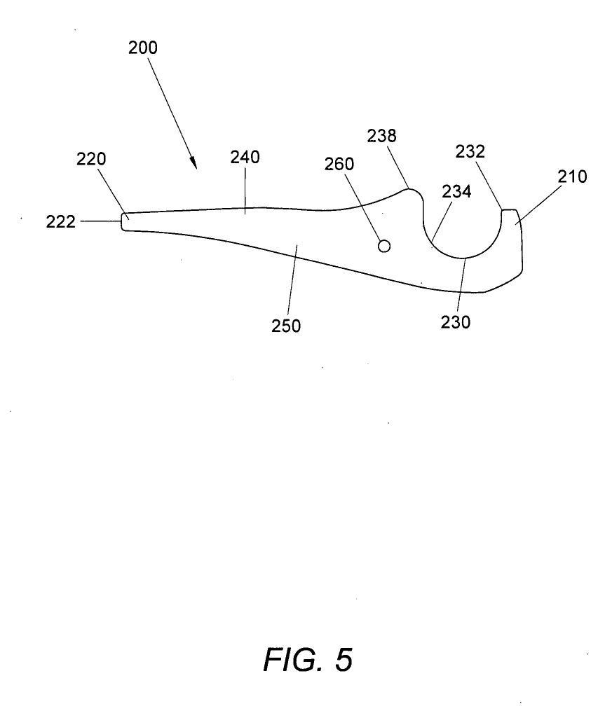

FIG. 5 is a side elevational view of the handle 200. The previously described nose 210, distal end 220, outer gripping region 240, inner region 250, workpiece receiving region 230 defined by a concave or recessed surface 234 extending between the handle ridge 238 and the second ridge 232 are shown. The handle 200 preferably further defines a tail end 222 defined at the rearward portion of the distal end 220. The handle 200 defines the aperture 260 that preferably provides access through the thickness of the handle.

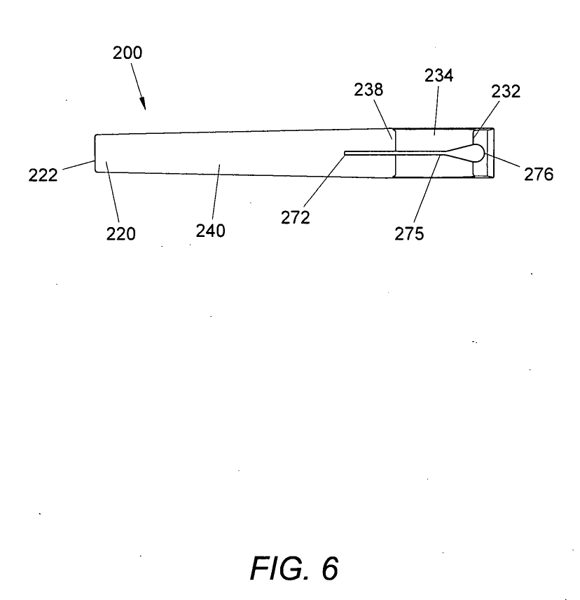

FIG. 6 is a detailed view of the handle 200 depicted in FIG. 5, illustrating a blade receiving slot 275. The handle 200 defines a blade receiving slot 275 that extends longitudinally from the second ridge 232, past and through the handle ridge 238, and toward the distal end 220, preferably slightly beyond, i.e. rearwardly, the aperture 260. The blade receiving slot includes a rearward portion 272 and a frontward portion 276. Preferably, the access span or width of the blade receiving slot 275 is greater in the region of the portion 276 than the region of the rearward portion 272. This configuration allows the blade to flex laterally during a cutting operation in which the blade is at least partially positioned within the blade receiving slot 275.

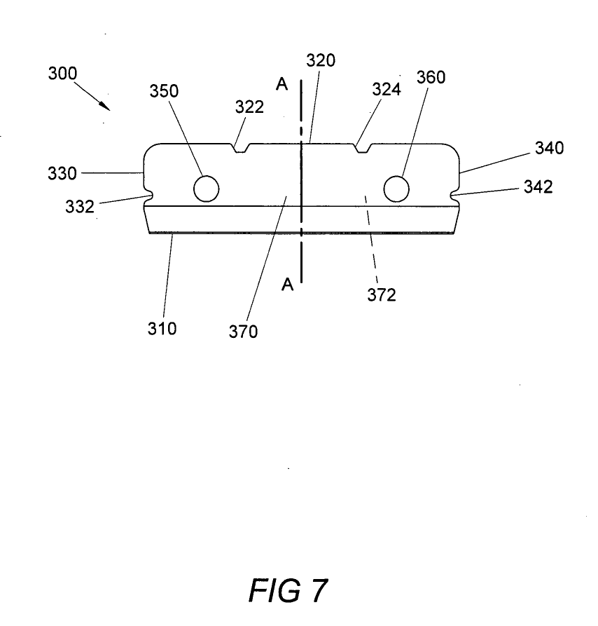

FIG. 7 illustrates in greater detail the preferred embodiment blade 300. The previously described cutting edge 310, lateral edges 330 and 340, and top edge 320 are noted. Preferably, the cutting edge 310 is linear, however the invention includes non-linear shapes or profiles such as serrated or arcuate. In addition, the previously described recessed regions 322, 324, 332, and 342 are shown. Previously described apertures 350 and 360 are illustrated. As will be appreciated, the blade defines two oppositely directed faces. These are denoted in FIG. 7 as faces 370 and 372. Preferably, the recessed regions 322 and 324 defined along the top edge 320 of the blade 300 are of equal width, depth, and configuration. Similarly, the recessed regions 332 and 342 defined along the lateral edges 330 and 340 of the blade 300, are of equal width, depth, and configuration. It is also preferred that the width of the top recess 322 is greater than the width of the lateral recess 332. And, it is preferred that the width of the top recess 324 is greater than the width of the lateral recess 342. The provision of top recesses having a greater width than corresponding lateral recesses aids in positioning and engagement of the blade 300 within the tool 400, and specifically, engagement with the retaining pins 172 and 174. Furthermore, it is preferred that the shape of the lateral recesses, such as 332 and 342, is arcuate and most preferably, semi-circular. Such a shape promotes pivoting of the blade against a retaining pin, during blade replacement. That is, when introducing a blade 300 into the tool 400, the lateral edge of the blade first contacts a retaining pin. Upon receipt of the pin in the lateral recess, the blade is then pivoted about that point of contact until the other retaining pin is contacted and received within the recess defined along the top edge of the blade. Another preferred aspect of the blade 300 is that the blade configuration is symmetrical with respect to a line of symmetry A-A shown in FIG. 7. That is, the configuration of the blade on each side of the line A-A is the same. Specifically, the lateral recesses are symmetrical with regard to each other, about line A-A. And, the recesses along the top edge are symmetrical with regard to each other, about line A-A. It is also preferred that the apertures are symmetrical with regard to each other, about line A-A. During use of the tool 400, it will be appreciated that only about one-half of the cutting edge 310 is used. Thus, after sufficient use of the blade 300, the other unused portion of the blade edge 310 can be used by removing and reversing the blade with respect to the handle 100. Upon reversal of the blade 300 with respect to the tool 400, this feature permits the entire length of the cutting edge 310 to be utilized before discarding or replacing the blade 300 with another.

The blade retention members, shown and described herein as the retaining pins 172 and 174, can be formed from nearly any suitable material. Preferably, the members are formed from metal or one or more polymeric materials. As noted, the blade retention members can be formed integral with their respective handle, or can be affixed or otherwise attached to the handle during assembly of the cutting tool. It is significant and an important feature of the present invention cutting tool, that the retaining pins be permanently attached or integrally formed with their corresponding handle.

The pivot member, shown and described herein as pivot member 380, can be in a wide array of different shapes and configurations. Preferably, the pivot member is in the form of a binding barrel having a relatively smooth cylindrical outer configuration and an open, female end that is threaded and which can engage either a separate and correspondingly threaded male connector or a threaded male connector provided in one of the handle sections. The pivot member may also be in the form of a conventional threaded member to which a corresponding threaded nut or other connector is engaged. The pivot member can be formed from a wide array of materials, such as, but not limited to steel, stainless steel, and various coated steels. Preferably, the pivot member is hand releasable from the handle or associated pivot member component to which it is engaged. “Easy open” fasteners are known in the art having small handles or provisions that can be raised above the head of the fastener from a folded or storage position in which the handle is generally positioned alongside the head. When raised above the head, the handle can be readily grasped by a user's thumb and forefinger for rotation of the fastener. However, the present invention includes embodiments in which the pivot member is removable by use of a device such as a screw driver.

The blade 300 is readily and easily replaced in the preferred embodiment cutting tool 400. Referring to FIG. 2 for example, in order to replace or reverse the blade 300, the pivot member 380 is disengaged from the assembly of handles 100 and 200, thereby allowing the handles to be separated or at least spaced apart from one another. Removal of the pivot member 380 also enables the blade 300 to be removed from the hollow receiving region defined in the handle 100. The blade can then be disengaged or otherwise withdrawn from the hollow region through the slot 175 defined in the handle 100. A new or replacement blade 300 can then be inserted into the slot 175, and a portion of the blade positioned within the hollow receiving region. As previously described, the new or replacement blade is appropriately positioned within the hollow receiving region defined in the handle such that the one or more retention members are disposed in the receiving slots defined along the blade edge. Or as noted, instead of using a new blade, the previous blade or a different, previously used blade having an acceptable cutting portion along its length, can be reversed and inserted into the receiving region. Once the blade has been appropriately positioned, the handles are aligned such that the pivot member apertures, i.e. apertures 160 and 260 defined in handles 100 and 200, respectively, are aligned. The pivot member 380 is then inserted into the apertures 160 and 260, and one of the blade apertures 350 or 360, and appropriately tightened or otherwise engaged with a corresponding member, or one of the handles. When changing the blade orientation in order to use another region of the cutting edge, this same procedure is followed except instead of obtaining a new or replacement blade, the previously used blade is reversed or otherwise repositioned in the receiving slot.

The handles can be formed entirely or partially, of a moldable, polymeric material. The handles could also be formed from one or more metals. Or, the handles could be formed from a combination of metals and polymeric materials. Preferably, the handles are provided with an aesthetic finish and textured outer surfaces in the regions where gripping will occur.

The present invention includes a wide array of cutting tools. For example, the invention includes two handled cutting tools, like tool 400 depicted in the referenced figures. It is also contemplated that the invention includes other types of cutting tools such as single handle tools. Moreover, for two handled tools, the invention includes the use of handles having other configurations such as having a slotted blade receiving region and the use of relatively long and linear handles. Instead, a handle having a flat or straight workpiece engaging surface can be used. Also, handles having oval or otherwise closed ends, such as typically used in conventional scissors, could be employed.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

1. A cutting tool comprising:
a first handle having a recessed receiving region adapted for retaining a workpiece, a distal end, and a body extending between the receiving region and the distal end; and
a second handle pivotally and releasably coupled to the first handle, the second handle having a blade attachment portion, a distal end, and an intermediate region extending between the blade attachment portion and the distal end, the second handle defining a hollow blade receiving region accessible through a blade receiving slot, the hollow blade receiving region defining a relatively flat blade receiving face, the second handle further having at least one blade retention member projecting from the blade receiving face and permanently affixed to or integral with the second handle, within the hollow blade receiving region.

2. The cutting tool of claim 1 wherein the second handle has a first blade retention member and a second blade retention member projecting from the blade receiving face.

3. The cutting tool of claim 2 wherein the blade attachment portion of the second handle defines a front end opposite the distal end of the second handle, the first blade retention member disposed within the hollow blade receiving region adjacent the front end of the second handle, and the second blade retention member disposed within the hollow blade receiving region between the first blade retention member and the distal end of the second handle.

4. The cutting tool of claim 1 wherein the second handle defines a hollow spring compartment accessible from a lateral side of the second handle.

5. The cutting tool of claim 4 further comprising a biasing member disposed in the spring compartment defined in the second handle.

6. The cutting tool of claim 1 further comprising:
a cutting blade, the blade defining a first face, an oppositely directed second face, at least one cutting edge, a perimeter edge extending about the remainder of the blade, and at least one receiving slot defined and accessible along the perimeter edge of the blade, the at least one receiving slot sized and shaped to engage the at least one blade retention member of the second handle.

7. The cutting tool of claim 6 wherein the second handle has a first blade retention member and a second blade retention member, and the cutting blade defines a first receiving slot along the perimeter edge of the blade and a second receiving slot along the perimeter edge of the blade, the blade being positioned in the blade receiving region and along the blade receiving face such that the first blade retention member is disposed in the first receiving slot and the second blade retention member is disposed in the second receiving slot.

8. The cutting tool of claim 7 wherein the blade further defines a third receiving slot along the perimeter edge of the blade and a fourth receiving slot along the perimeter edge of the blade.

9. A tool adapted for cutting tubing or other cylindrical members, the tool comprising:
a first handle having a recessed receiving region, a distal end, and a body extending between the receiving region and the distal end, the first handle defining a generally hollow interior accessible along an underside of the handle;
a second handle at least partially disposed within the hollow interior of the first handle, the second handle pivotally and releasably coupled to the first handle, the second handle defining a blade attachment portion, a distal end, and an intermediate region extending between the blade attachment portion and the distal end, the blade attachment portion defining hollow blade receiving region including a blade receiving face and at least one blade retention member projecting from the blade receiving face and permanently affixed or integral with the second handle; and
a cutting blade having two oppositely directed blade faces, a cutting edge, a non-cutting edge, and at least one receiving slot defined and accessible along the non-cutting edge, the cutting blade disposed along the blade receiving face of the second handle such that one of the blade faces contacts the blade receiving face of the second handle and at least one of the blade retention members is disposed within a receiving slot of the cutting blade.

10. The tool of claim 9 wherein the second handle has a first blade retention member and a second blade retention member, both retention members projecting from the blade receiving face, and the cutting blade defines a first receiving slot and a second receiving slot, both slots defined along the non-cutting edge of the blade, the cutting blade disposed along the blade receiving face of the second handle such that the first blade retention member is disposed in the first receiving slot and the second blade retention member is disposed in the second receiving slot.

11. The tool of claim 9 wherein the second handle defines a generally hollow compartment accessible from a side of the second handle, the tool further comprising:
a biasing member disposed in the hollow compartment defined in the second handle, the biasing member including a first end in contact with the first handle and a second end in contact with the second handle, the biasing member configured so as to urge the distal ends of the first and second handles apart from one another.

12. The tool of claim 10 wherein the cutting blade further defines a third receiving slot and a fourth receiving slot, both third and fourth receiving slots defined along the non-cutting edge of the cutting blade.

13. The tool of claim 9 wherein the cutting blade is generally rectangular and the cutting edge extends across the length of the cutting blade.

14. A cutting tool comprising:
a pair of handles pivotally and releasably engaged to one another, one of the handles defining a blade receiving face and at least one permanent blade retention member projecting outward from the face; and
a cutting blade defining at least one receiving slot along an edge of the blade, the blade disposed alongside and contacting the blade receiving face such that at least one blade retention member is positioned generally within at least one receiving slot of the cutting blade.

15. The cutting tool of claim 14 wherein one of the handles define a first blade retention member and a second blade retention member both projecting outward from the blade receiving face.

16. The cutting tool of claim 15 wherein the cutting blade defines a first receiving slot and a second receiving slot, and the blade is positioned such that the first blade retention member is disposed within the first receiving slot and the second blade retention member is disposed within the second receiving slot.

17. The cutting tool of claim 14 further comprising:
a biasing member engaging the pair of handles and positioned relative to the pair of handles such that the handles are pivoted apart from one another.

18. The cutting tool of claim 14 wherein the at least one blade retention member is formed from a metal.

19. The cutting tool of claim 14 wherein the at least one blade retention member is formed from a polymeric material.

20. The cutting tool of claim 14 wherein the pair of handles are pivotally and releasably engaged to one another by an aperture defined in at least one of the handles and a pivot member extending through the aperture, the pivot member being releasably engageable with the other handle.

21. A cutting blade adapted for incorporation in and use with, a cutting tool, the cutting blade having a first face and an oppositely directed second face, a linear cutting edge, an opposite first non-cutting edge, a lateral second non-cutting edge extending between the cutting edge and the first non-cutting edge, and a lateral third non-cutting edge also extending between the cutting edge and the first non-cutting edge, the blade defining a first aperture extending through the blade between the first and second faces, a second aperture extending through the blade between the first and second faces, a first recess along the lateral second non-cutting edge, and a second recess along the lateral third non-cutting edge.

22. The cutting blade of claim 21 wherein the first recess and the second recess are symmetrically defined along their corresponding lateral edges, with regard to a line of symmetry extending across the midpoint of the blade and perpendicular to the cutting edge of the blade.

23. The cutting blade of claim 22 wherein the first aperture and the second aperture are symmetrically defined in the blade, with regard to the line of symmetry.

24. The cutting blade of claim 21 further defining a third recess and a fourth recess defined along the first non-cutting edge.

25. The cutting blade of claim 24 wherein the third recess and the fourth recess are symmetrically defined along the first non-cutting edge with regard to the line of symmetry.
